(19) United States
(12) Patent Application Publication
(10) Pub. No.: US 2002/0190589 A1
(43) Pub. Date: Dec. 19, 2002

(54) Direct current brushless type vibration motor

(75) Inventors: Alex Horng, Kaohsiung (TW); Ching-Shen Hong, Kaohsiung (TW); Tso-Kuo Yin, Kaohsiung Hsien (TW)

Correspondence Address: Bacon & Thomas, 625 Slaters Lane - 4th Floor, Alexandria, VA, 22314, US

(73) Assignee: Sunonwealth Electric Machine Industry Co., Ltd., Kaohsiung (TW)

(21) Appl. No.: 09/879,976

(22) Filed: Jun. 14, 2001

(51) Int. Cl. H02K 7/06

(52) U.S. Cl. 310/81

(57) ABSTRACT

A direct current brushless type vibration motor primarily includes a cylindrical housing having a bottom provided with a pivot hole, and a top having an opening end. A stator seat is fixed in the inner wall of the housing, and is provided with coils and poles. The poles of the stator seat mate with the permanent magnet of the rotor. The rotor has a shaft whose two ends are respectively pivoted in the pivot hole of the bottom of the housing, and the pivot hole provided by the cover plate and the circuit board that close the opening end of the housing. The shaft has an integral permanent magnet and an eccentric member. The circuit board is fixed in the housing and has a sensing drive circuit.

### BACKGROUND OF THE INVENTION

1. Field of the Invention

The present invention relates to a direct current brushless type vibration motor, and more particularly to the eccentric block of direct current brushless type vibration motor, which may obtain a better protection, and the direct current brushless type vibration motor may be easily processed and manufactured.

2. Description of the Related Art

A conventional direct current brushless type vibration motor in accordance with the prior art shown in FIG. 1 comprises an upper casing 90 and a lower casing 91 mutually fixed with each other. The upper casing 90 and the lower casing 91 are each provided with seats 92 protruding upward and downward. The seat 92 is provided with a bearing 93 received therein. A rotation shaft 94 is pivoted with the upper and lower bearings 93, and is provided with a permanent magnet 95 induced with a coil seat 96. The rotation shaft 94 is protruded outward from the upper casing 90 to combine with an eccentric member 97. After the permanent magnet 95 is induced with the coil seat 96, the rotation shaft 94 may be rotated. The rotation shaft 94 is provided with the eccentric member 97. Thus, the motor will produce vibration during rotation.

In the conventional direct current brushless type vibration motor, the eccentric member 97 is mounted on the rotation shaft 94 that protrudes outward from the upper casing 90, so that the eccentric member 97 easily hits or tangles with other elements or the electric wire during rotation, thereby easily wearing the parts of the vibration motor. In addition, the conventional direct current brushless type vibration motor is more inconvenient during fabrication.

### SUMMARY OF THE INVENTION

The primary objective of the present invention is to provide a direct current brushless type vibration motor, wherein the miniature motor has a simpler structure, and may be processed and manufactured conveniently.

A secondary objective of the present invention is to provide a direct current brushless type vibration motor, wherein the rotation member and the eccentric member of the vibration motor may obtain better protection.

In accordance with the present invention, there is provided a direct current brushless type vibration motor including a cylindrical housing having a bottom provided with a pivot hole, and a top having an opening end. A stator seat is fixed in the inner wall of the housing, and is provided with coils and poles. The poles of the stator seat mate with the permanent magnet of the rotor. The rotor has a shaft whose two ends are respectively pivoted in the pivot hole of the bottom of the housing, and the pivot hole provided by the cover plate and the circuit board that close the opening end of the housing. The shaft has an integral permanent magnet and an eccentric member. The circuit board is fixed in the housing and has a sensing drive circuit.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional assembly view of a conventional direct current brushless type vibration motor in accordance with the prior art;

FIG. 2 is an exploded perspective view of a direct current brushless type vibration motor in accordance with a first embodiment of the present invention;

FIG. 3 is a cross-sectional assembly view of the direct current brushless type vibration motor as shown in FIG. 2;

FIG. 4 is a cross-sectional assembly view of a direct current brushless type vibration motor in accordance with a second embodiment of the present invention; and

FIG. 5 is a cross-sectional assembly view of a direct current brushless type vibration motor in accordance with a third embodiment of the present invention.

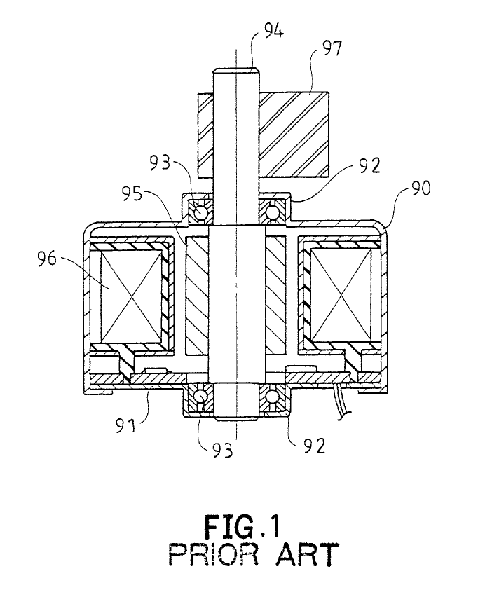

### DETAILED DESCRIPTION OF THE PREFERRED EMBODIMENTS

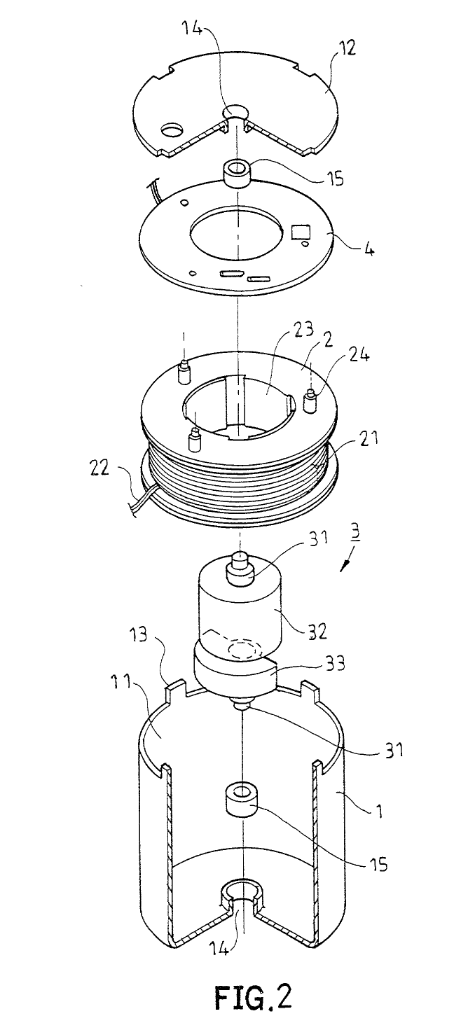

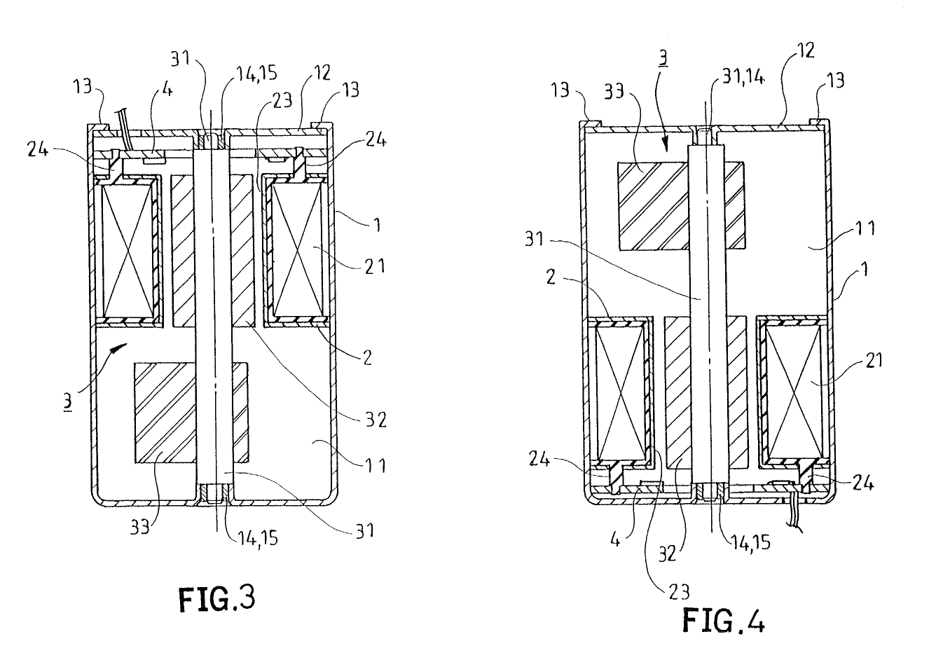

Referring to the drawings and initially to FIGS. 2 and 3, a direct current brushless type vibration motor in accordance with a first embodiment of the present invention comprises a housing 1, a stator seat 2, a rotor 3, and a circuit board 4.

The housing 1 may be formed with a cylinder shape, and has an opening end 11 which may be covered by a cover plate 12 which may be fixed by bending and folding the fixing flanges 13 formed on the housing 1. The housing 1 and the cover plate 12 have mating pivot holes 14 for pivoting two ends of the rotor 3. In the preferred embodiment, in the two pivot holes 14 provided by the housing 1 and the cover plate 12, when one pivot hole 14 is provided with a bearing 15, rotation of the shaft 31 of the rotor 3 will have a better stability.

The stator seat 2 is fixed in the housing 1. In the preferred embodiment, the stator seat 2 is fixed in the inner wall of the housing 1 in a close fit manner, and is combined with the circuit board 4 by posts 24. The stator seat 2 is wound with coils 21 connected to a power supply by a terminal wire. The stator seat 2 has poles 23 that may be induced with the permanent magnet 32 of the rotor 3, to drive the rotor 3 to rotate.

The two ends of the shaft 31 of the rotor 3 are pivoted in the pivot hole 14 or the bearing 15 provided by the housing 1 or the cover plate 12. The rotor 3 has an integral permanent magnet 32 and an eccentric member 33. The permanent magnet 32 of the rotor 3 may be induced with the poles 23 of the stator seat 2, to drive the rotor 3 to rotate. In the preferred embodiment, the rotor 3 is provided with the eccentric member 33, and is mounted in the housing 1 at the side of the stator seat 2. Thus, the center of gravity and the center of rotation of the rotor 3 are not at the same central line. Thus, when the rotor 3 is rotated, the entire motor may form vibration. The permanent magnet 32 and the eccentric member 33 are disposed in the housing 1. Thus, when the rotor 3 is rotated, the permanent magnet 32 and the eccentric member 33 will not hit or tangle with other elements or power supply wire. In addition, when the two ends of the shaft 31 of the rotor 3 are respectively pivoted in the pivot holes 14 provided by the housing 1 and the cover plate 12, the shaft 31 and the pivot hole 14 are not fit in a close manner. Thus, when the rotor 3 is rotated, the motor will have a better upward and downward vibration effect. In addition, in the two pivot holes 14 provided by the housing 1 and the cover plate 12, one pivot hole 14 is provided with the bearing 15 for pivoting of one end of the shaft 31. Thus, when the rotor 3 is rotated, the motor will have better stability and have a better upward and downward vibration effect.

The circuit board 4 may be fixed in the housing 1, or as shown in the figure, the circuit board 4 is fixed on the stator seat 2. The circuit board 4 has a sensing drive circuit, including the conventional IC, hall sensor and other necessary elements.

Referring to FIG. 3, the assembling situation of the direct current brushless type vibration motor in accordance with a first embodiment of the present invention is shown. The stator seat 2 is fixed in the inner wall of the housing 1. The shaft 31 is passed through the permanent magnet 32 and the eccentric member 33. The two ends of the shaft 31 of the rotor 3 are pivoted in the pivot hole 14 or the bearing 15 of the housing 1 and the cover plate 12 respectively, and the fixing flanges 13 are bent to fix the cover plate 12, thereby assembling the direct current brushless type vibration motor which can be processed conveniently and easily, and the eccentric member 33 is rotated in the housing 1. Thus, the eccentric member 33 will not hit or tangle with other elements or power supply wire.

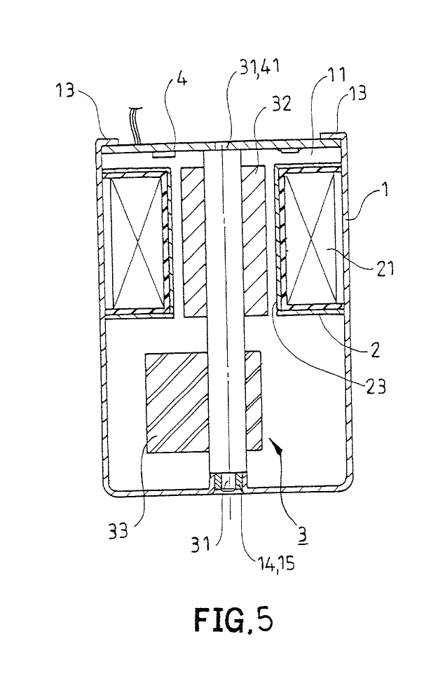

Referring to FIG. 4, a direct current brushless type vibration motor in accordance with a second embodiment of the present invention comprises a cylindrical housing 1 whose inner bottom is serially provided with the circuit board 4, and the stator seat 2 therein. The pivot hole 14 of the housing 1 is provided with the bearing 15 pivoted with one end of the shaft 31 of the rotor 3. The shaft 31 has a permanent magnet 32 and an eccentric member 33. The IS permanent magnet 32 mates with the poles 23 of the stator seat 2, so that the rotor 3 is induced to rotate. The eccentric member 33 is disposed in the upper portion of the housing 1. The opening end 11 of the housing 1 is closed by the cover plate 12 which is fixed by bending the fixing flanges 13. The other end of the shaft 31 is pivoted in the pivot hole 14 of the cover plate 12. Thus, the direct current brushless type vibration motor can be assembled and processed conveniently and easily, and the eccentric member 33 is rotated in the housing 1. Thus, the eccentric member 33 will not hit or tangle with other elements or power supply wire.

Referring to FIG. 5, a direct current brushless type vibration motor in accordance with a third embodiment of the present invention comprises a cylindrical housing 1 whose inner bottom is provided with a pivot hole 14 which is provided with the bearing 15 pivoted with one end of the shaft 31 of the rotor 3. The shaft 31 has an integral permanent magnet 32 and an eccentric member 33. The permanent magnet 32 mates with the poles 23 of the stator seat 2, and the stator seat 2 is fixed in the inner wall of the housing 1. The other end of the shaft 31 of the rotor 3 is directly pivoted in the pivot hole 14 of the circuit board 4. The opening end 11 of the housing 1 is closed by the circuit board 4 which is fixed by bending the fixing flanges 13. Thus, the circuit board 4 can be used to close the opening end 11 of the housing 1. Thus, the direct current brushless type vibration motor according to the present invention can be assembled conveniently and processed easily. In addition, the eccentric member 33 is rotated in the housing 1. Thus, the eccentric member 33 will not hit or tangle with other elements or power supply wire.

Accordingly, the direct current brushless type vibration motor in accordance with the present invention can be assembled conveniently and can be processed easily. In addition, the eccentric member is rotated in the housing. Thus, the eccentric member will not hit or tangle with other elements or power supply wire. Further, when the two ends of the shaft are directly pivoted in the pivot holes, the rotor may produce upward and downward vibration effects during rotation thereof. Further, when the two ends of the shaft are pivoted in the pivot hole and the bearing respectively, the rotor may have stable rotation and have upward and downward vibration effects during rotation thereof.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A direct current brushless type vibration motor, comprising:
a housing, formed with a cylindrical shape, the housing having a bottom provided with a pivot hole, and a top having an opening end which is closed by a cover plate, the cover plate having a pivot hole;
a stator seat, fixed in an inner wall of the housing, and provided with coils and poles;
a rotor, having a shaft having one end pivoted in the pivot hole of the bottom of the housing, the shaft having an integral permanent magnet and an eccentric member, the permanent magnet mating with the poles of the stator seat, the eccentric member mounted in the cylindrical housing at a side of the stator seat, the other end of the shaft pivoted in the pivot hole of the cover plate;
a circuit board, fixed in the housing, the circuit board having a sensing drive circuit.

2. The direct current brushless type vibration motor as claimed in claim 1, wherein in the two pivot holes of the housing and the cover plate, one pivot hole is provided with a bearing.

3. The direct current brushless type vibration motor as claimed in claim 1, wherein the stator seat is provided with posts combined with the circuit board.

4. The direct current brushless type vibration motor as claimed in claim 1, wherein the circuit board and the stator seat are fixed in an inner bottom of the cylindrical housing.

5. The direct current brushless type vibration motor as claimed in claim 1, wherein the circuit board and the stator seat are fixed in an opening end of the cylindrical housing.

6. A direct current brushless type vibration motor, comprising:
a housing, formed with a cylindrical shape, the housing having a bottom provided with a pivot hole, and a top having an opening end;
a stator seat, fixed in an inner wall of the housing, and provided with coils and poles;
a circuit board, having a sensing drive circuit and a pivot hole, the circuit board capable of closing the opening end of the housing;
a rotor, having a shaft having one end pivoted in the pivot hole of the bottom of the housing, the shaft having an integral permanent magnet and an eccentric member, the permanent magnet mating with the poles of the stator seat, the eccentric member mounted in the cylindrical housing at a side of the stator seat, the other end of the shaft pivoted in the pivot hole of the circuit board.

7. The direct current brushless type vibration motor as claimed in claim 6, wherein in the two pivot holes of the housing and the circuit board, one pivot hole is provided with a bearing.
